(19) United States
(12) Patent Application Publication
(10) Pub. No.: US 2020/0410880 A1
(43) Pub. Date: Dec. 31, 2020

(54) DINING SURFACE PREPARATION SYSTEMS

(71) Applicant: Michael Cope, Collierville, TN (US)

(72) Inventor: Michael Cope, Collierville, TN (US)

(21) Appl. No.: 16/457,886

(22) Filed: Jun. 28, 2019

(51) Int. Cl. G09B 1/00

(52) U.S. Cl. CPC G09B 1/00

(57) ABSTRACT

A dining surface preparation apparatus and system is provided. The apparatus includes a base. The base is configured to interface with a dining surface area. The dining surface preparation apparatus also includes an item identification system. The item identification apparatus is positionable on the base and is arranged to provide identification of dining items. Additionally, the dining surface preparation apparatus includes an item location system. The item location system is positionable on the base and is configured to provide location of dining items on the dining surface area.

### BACKGROUND OF THE INVENTION

### 1) Field of the Invention

The present invention relates generally to surface preparation systems, and more particularly, to dining surface preparation systems.

### 2) Description of Related Art

Many methods and systems have been used unsuccessfully attempting to provide dining staff with the proper instructions and training to set a table for a particular event. Several devices and methods have been created to rectify the problem of improperly setting a table for a specific event. These devices, systems and methods have not been reliable or effective.

Throughout the world, different cultural norms result in different standards for how a table is be set. Quite often businesses and governments plan and host dining events for foreign dignitaries and unfortunately errors are made in appropriately setting the tables. These mistakes occur because of the organizations inability to understand the different norms and to properly train their staff in setting the table in accordance with these specific norms. These errors and mistakes cause embarrassment and potentially are interpreted as disrespectful by the foreign guests.

As the entire global economy expands, businesses find themselves trying to capture markets that are more international than just regional. For example, in the cruise line industry, major cruise line operators now target markets all over the world. Quite often, these cruise line operators utilize the same crew and staff to provide the cruise experience for all of their international clients. Unfortunately, most often the staff are not properly trained to memorize all the different settings required for different areas of the world. This results in improperly set tables. Cruise line operators unsuccessfully attempt to provide oversight of their staff to prevent these mistakes, but these ineffective efforts result in additional operational costs, additional logistical time required to set tables, and are not always accurate.

As the national security needs of different countries change, so do the different country's needs for building alliances with other countries. Hosting state dinners for foreign dignitaries with unusual or different standards for dining create a problem for the dining staff to properly set the table in accordance with these new social norms. The oversight required to train the staff with these different dining arrangements is costly, requires more time to set up, and is not 100% effective.

In most organizations, the personnel tasked with setting tables for a dining event are often the least senior. Quite often these personnel lack training and the propensity for attention to detail to properly set a table. In order to compensate, management has to devote time for oversight. This is costly, time consuming, and does not provide for 100% accuracy.

In large organizations, such as international hotel chains, military units, and other governmental entities, there is usually a high turnover ratio in the front-line positions. The front-line positions are typically tasked with setting up dining areas including setting the dining tables. Because of the high turnover of staff, there tends to be a lack of consistency in how tables are set. There is a need to provide a system or method to provide an increased consistency in properly setting up dining tables.

Often, specialty meals require different utensils and dinnerware. For example, meals consisting of escargot, lobster, fried chicken, barbeque ribs, crab legs, and/or corn on the cob require additional dining instruments such as, but not limited to, escargot tongs, shell cracking devices, corn cob holders, finger rinsing bowl for seafood meals, and/or receptacle containers for shells. Because of the complexity and differences between different meals and the different table settings required, it is difficult to train staff how to properly set the table for these variations. Most of these evolutions require more supervisor oversight and additional training which results in increased time, costs, and is usually not effective to make sure all these variations are addressed when setting the table.

Accordingly, there is an established need for a surface preparation system which solves at least one of the aforementioned problems. Further, there is an established need for a dining surface preparation system which provides an accurate system, apparatus, and/or method to set a table in an efficient, effective, and time sensitive fashion, reduce operating costs, is reusable, reduces waste, provides all personnel with the tools, devices, and systems to set a table in accordance with specific standards.

### BRIEF SUMMARY OF THE INVENTION

The invention in one form is directed to a dining surface preparation apparatus. The apparatus includes a base. The base is configured to interface with a dining surface area. The dining surface preparation apparatus also includes an item identification system. The item identification system is positionable on the base and is arranged to provide identification of dining items. Additionally, the dining surface preparation apparatus includes an item location system. The item location system is positionable on the base and is configured to provide location of dining items on the dining surface area.

The invention in another form is directed to a dining surface preparation system. The system includes a dining surface apparatus and at least one dining device. The dining surface apparatus includes a base. The base is configured to interface with a dining surface area. The dining surface preparation system also includes an item identification system. The item identification system is positionable on the base and is arranged to provide identification of dining items. Additionally, the dining surface preparation system includes an item location system. The item location system is positionable on the base and is configured to provide location of dining items on the dining surface area.

According to yet another aspect of the present invention, a method for preparing a dining surface is provided. The method includes interfacing a base with a dining surface area. The method also includes identifying dining items with an item identification system positionable on the base. Further, the method includes locating dining items on the dining surface area with an item location system positionable on the base.

An advantage of the present invention is a convenient, effective, efficient and labor-saving dining surface preparation apparatus, which can be used to ensure that tables are properly set for specific dining functions.

Another advantage of the present invention allows for training to ensure that tables are properly set for specific dining functions.

These and other objects, features, and advantages of the present invention will become more readily apparent from the attached drawings and the detailed description of the various embodiments, which follow.

### BRIEF DESCRIPTION OF THE DRAWINGS

The various embodiments of the invention will hereinafter be described in conjunction with the appended drawings provided to illustrate and not to limit the invention, where like designations denote like elements, and in which:

FIG. 1 presents a top perspective view of a dining surface preparation system, in accordance with an embodiment of the present invention;

FIG. 2 presents a top perspective view of a dining surface preparation system in accordance with an embodiment of the present invention;

FIG. 3 presents a top perspective view of an aspect of a dining surface preparation system with dining items;

FIG. 4 presents a top view of an aspect of a dining surface preparation system with dining items;

FIG. 5 presents a top perspective view of an embodiment of a dining surface preparation system with a specialty item template;

FIG. 6 presents a top perspective view of an embodiment of a dining surface preparation system with a specialty item template; and

FIG. 7 presents a cross sectional view of an aspect of a dining surface preparation system.

Like reference numerals refer to like parts throughout the several views of the drawings.

### DETAILED DESCRIPTION

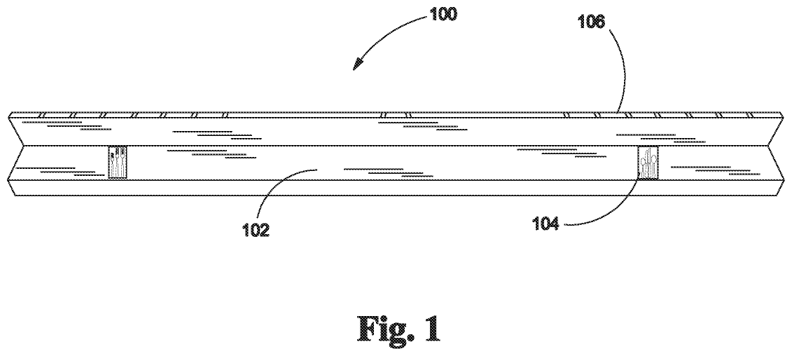

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, embodiments of the present invention are directed towards methods, systems, and apparatus of dining surface preparation wherein the systems, methods, and apparatus are configured to be used as training aids and as tools for personnel to set a dining table.

FIG. 1 presents a top perspective view of an embodiment of a dining surface preparation apparatus 100. The apparatus 100 can include a base 102. The base 102 can be configured to interface with a dining surface area. The apparatus 100 can also include an item identification system 104. The item identification system 104 can be positionable on the base 102 and can be configured to provide identification of dining items. The apparatus can further include an item location system 106 positionable on the base 102 and designed to provide location of dining items on the dining surface area. The apparatus 100 can include bases 102 with curves. The curves can include sections corresponding to, but not limited to, for example 60-inch and 72-inch round tables. The sector corresponding to the arc for a particular table size can be calculated:

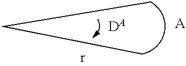

Therefore, the sector for a 60-inch table can be calculated.

D_{A1}=180°A/πr=180°×23.5″/π×30″=44.88°

Likewise, the sector for a 72-inch table can be calculated.

D_{A2}=180°A/πr=180°×22.6″/π×36″=35.97°

The dining surface preparation apparatus 100 can include a plurality of placement devices, the devices may include utensil placement markings. The dining surface preparation apparatus 100 can further include devices made of materials such as, but not limited to, wood, plastic, ceramic, composites, and/or metal.

The dining surface preparation apparatus 100 can also include ribbed posts or grooves on the devices, the ribbed posts or grooves configured to indicate location of specific utensils, glasses, and other dining ware and devices. The dining surface preparation apparatus 100 can include devices with special markings, the special markings configured to indicate location and placement of specialty dining devices and equipment such as, but not limited to, escargot tongs, crab shell cracking devices, finger rinsing bowl for seafood meals, corn on the cobb holders, and/or shell receptacles.

The dining surface preparation apparatus 100 can include a plurality of devices, the plurality of devices configured to provide proper placement and location of dining devices, e.g., utensils, plates, bowls, and glasses, for, but not limited to, breakfast, brunch, lunch, dinner, informal dining, special cultural dining, and/or formal dining. The dining surface preparation apparatus can also include a plurality of devices, the plurality of devices configured to provide proper placement and location of utensils, glasses, and other dining instruments and devices for, but not limited to, various cultural and/or social norms of countries all over the world.

The dining surface preparation apparatus 100 can include a plurality of devices, the plurality of devices configured to provide proper placement and location of utensils, glasses, and other dining instruments and devices for, but not limited to, square, oval, rectangular, trapezoidal, and/or circular dining tables. The tables ranging in size from 2, 4, 6, 8, 10, 12, 14, 16, 18, 20, 40 feet in diameter, and/or length, and/or width and/or any dimension in between.

In one embodiment, the dining surface preparation apparatus 100, includes a plurality of devices, the plurality of devices configured to provide proper placement and location of utensils, glasses, and other dining instruments and devices for a 60-inch round table. The devices including a length of 23.5 inches and a 44.88 degree of curvature.

In another embodiment, the dining surface preparation apparatus 100, includes a plurality of devices, the plurality of devices configured to provide proper placement and location of utensils, glasses, and other dining instruments and devices for a 72-inch round table. The devices including a length of 22.6 inches and a 35.97 degree of curvature.

The dining surface preparation apparatus 100, can also include a plurality of devices, the plurality of devices configured to provide proper placement and location of utensils, glasses, and other dining instruments and devices for a straight table, the device can include a length of 24 inches.

The dining surface preparation apparatus 100 can include a base 102 wherein the base includes an interface height of any suitable height to interface with an edge of a table. A table will typically require an interface of 13/16 inches. However, it is to be understood that the interface height may be of any suitable height to ensure proper interfacing with an edge of a table. It should be further understood that the interface height may be of any shape suitable for interfacing with the edge of a table, e.g., straight, curved, angular. The dining surface preparation apparatus 100 can also include a base 102 wherein the base 102 includes a width. The width may be of any distance suitable for proper placement of utensils. A typical range may be from 1½″ to 2″. Typically, the width is approximately 1 13/16 inches with the base configured to rest on top of a table allowing equal spacing of utensils from an edge of the table. The dining surface preparation apparatus 100 can further include an item identification system and an item location system wherein the systems include a height suitable for proper engagement with utensils and plates. Generally, a height of 1 15/16 inches allows utensils and plates to rest for uniform lines.

The base 102 may be of any length suitable to allow for use with an item identification system and an item location system. The length may be fixed or adjustable. The length of the base 102 may be adjustable by any acceptable way, e.g., telescoping members, folding members, interlocking members. The length of the base 102 can be such that when two or more bases 102 are placed end to end, an equidistant spacing is achieved. For instance, a 60″ round table having 8 settings requires a base 102 having a length of approximately 23.6″. Whereas a 60″ round table having 6 settings requires a base 102 having a length of approximately 31.4″. The required length of a base 102 for a round table setting can be calculated by dividing the circumference of the table by the number of required settings. For a straight edge table, the typical length of the base 102 may be 24″. However, it is to be understood that the length may be of any distance suitable for the number of settings required or needed.

The dining surface preparation apparatus 100 can include a small lip to bump against an edge of a table with an inch going inward towards a center of the table with a vertical section, the vertical section configured to allow utensils to rest against the vertical section to create a uniform straight line. The dining surface preparation apparatus 100 can also include a flat upper portion, the flat upper portion can include etchings, the flat upper portion configured to rest on a table. The dining surface preparation apparatus 100 can include etchings on a left side to indicate placement of forks are on the left side and etchings on a right side to indicate placement of knives and spoons are on the right side.

The dining surface preparation apparatus 100 can include plastic or wood with no edges and no ability to stain. The system is configured to be used as a training aid and as an actual tool used in setting tables. The dining surface preparation apparatus 100 can also include wood and plastic without any sharp edges, wherein the edges are beveled configured to prevent scratches and to minimize the ability for snags. The dining surface preparation apparatus 100 can include manufacturing of the system without any dies that can cause stains.

The dining surface preparation apparatus 100 can include notches on a top of a vertical section to indicate a center. Further, the system can include ½ inch interval spacing notches, the spacing notches starting from the center to a distance of 5 inches from the center. The spacing notches arranged to allow precise measurements on either side of the plate for precise placement of utensils. The dining surface preparation apparatus 100 can also include an item identification system. The item identification system can include pictures, graphics, icons, outlines, written words, different colors, and/or 3-dimensional representations of dining items. The dining surface preparation apparatus 100 can include an item location system. The item location system can include notches, ridges, ribs, bumps, grooves, written descriptions, distances, coordinates, and/or templates configured to provide location of dining items on a dining surface area.

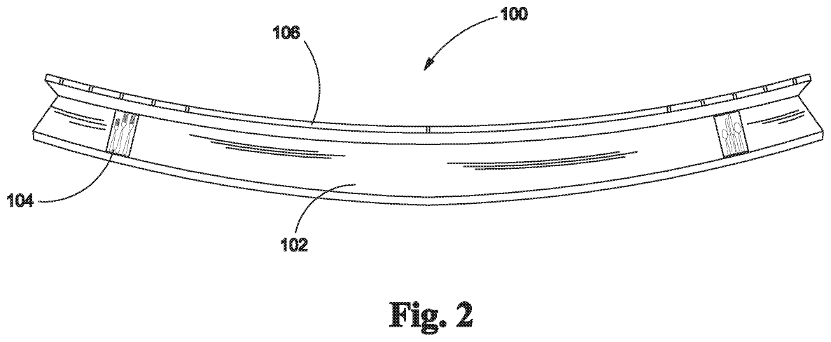

Turning to FIG. 2, a top perspective view of an embodiment of a dining surface preparation apparatus 100 configured for a flat table edge is illustrated. The apparatus 100 can include a base 102, an item identification system 104, and an item location system 106.

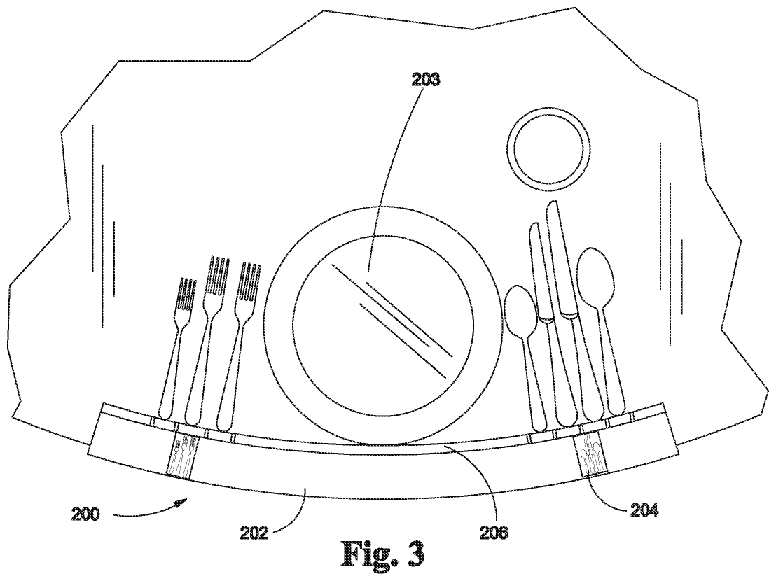

As best seen in FIG. 3, a top perspective view of an embodiment of a dining surface preparation system 200 with a curved base 202 with corresponding dining devices 203 are displayed. The corresponding dining devices 203 are aligned with both the graphic display of the item identification system 204 and the notches corresponding to the location markings of the item location system 206. Further, the system 200 also shows a container template 208 deployed with the system 200 to identify and locate a container, e.g., a water goblet, a champagne flute, or a wine glass on the dining surface area.

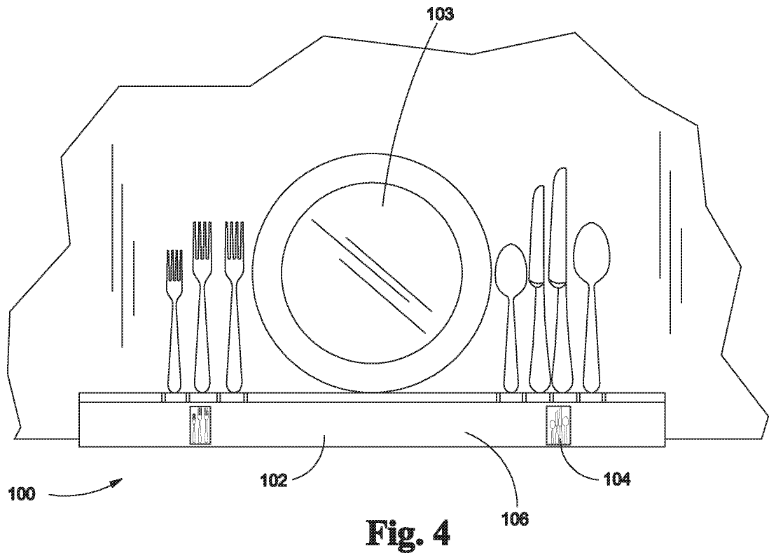

Referencing FIG. 4. a top view of an embodiment of a dining surface preparation system 200 configured for a flat edge table and with corresponding dining devices 203 located on the dining area surface is shown. As can be seen on a left side on the item identification system 204, there are graphics corresponding to forks. Further, on a right side of the system 200 there are graphics corresponding to spoons and knives. A center marking in the systems 200, 204, and 206 locates the position for a plate.

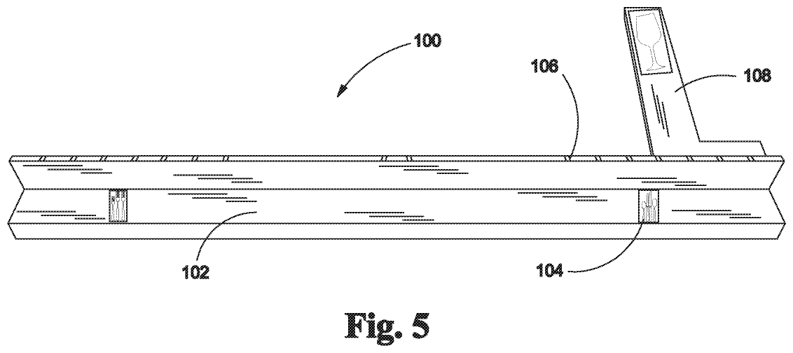

As seen in FIG. 5, a top perspective view of the dining surface preparation apparatus 100 configured for a flat edge table is shown with a container template 108 deployed. As illustrated, the location of the container template 108 is identified and located by graphics on the item identification system 104 and the location is specified by the item location system 106.

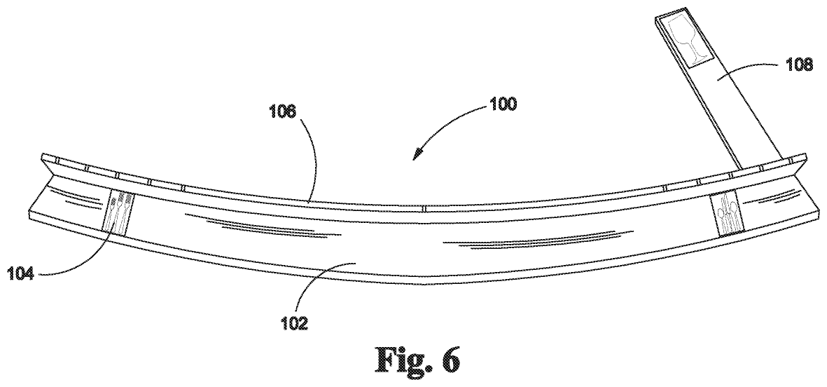

And as shown in FIG. 6, a top perspective view of the dining surface preparation apparatus 100 configured for a curved edge table is shown with a container template 108 deployed. As illustrated, the location of the container template 108 is identified and located by graphics on the item identification system 104 and the location is specified by the item location system 106.

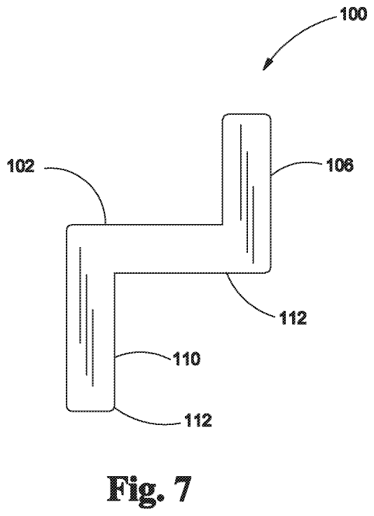

FIG. 7 displays a cross sectional view of an embodiment of a dining surface preparation apparatus 100. The apparatus 100 can include a base 102 with a lip section 110 configured to meet up with the edge of the dining surface area. The dining surface preparation apparatus 100 may also include a surface preparation 112. The dining surface preparation apparatus 100 can further include devices with a surface preparation 112 on surfaces of the devices. The surface preparation 112 may be configured to inhibit or promote movement of the dining surface preparation apparatus 100 relative to a dining surface area and to prevent staining of the dining surface area. The surface preparation 112 may include a structural alteration to the devices of the apparatus 100, e.g., ridges, groves, bumps, and knurling. The surface preparation 112 may also include an alternate material attached to the apparatus 100, e.g., rubber, foam, fabric, metal, polyurethane, polyoxymethylene, and polyethylene. Attachment of the surface preparation 112 to the apparatus 100 can be accomplished with any acceptable method such as chemical, mechanical, and electromagnetic. The surface preparation 112 may be used to resist movement of the apparatus 100 caused by personnel inadvertently bumping into the system or allow movement of the apparatus 100 about a dining surface area.

It should be noted that the dining surface apparatus 100 may be configured to attach to the dining surface area. Attachment of the dining surface apparatus 100 may be accomplished with any method suitable to prevent movement between the apparatus 100 and the dining surface area. Methods to attach may include devices such as clips, springs, wedges, detent pins. The attachment devices may be formed integral to or attached to the dining surface apparatus 100.

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above described embodiment, method and examples, but all embodiments and methods within the scope and spirit of the exemplary embodiments as claimed.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

Insofar as the description above and the accompanying drawings disclose any additional subject matter that is not within the scope of the claims below, the inventions are not dedicated to the public and the right to file one or more applications to claim such additional inventions is reserved.

What is claimed is:

1. A dining surface preparation apparatus comprising:
a base configured to interface with a dining surface area;
an item identification system positionable on the base arranged to provide identification of at least one dining item; and
an item location system positionable on the base and configured to provide location of the at least one dining item on the dining surface area.

2. The apparatus as recited in claim 1, wherein the base is configured to interface with a dining surface area having a circular, a square, a rectangular, an oval, or a trapezoidal shape.

3. The apparatus as recited in claim 1, wherein the item identification system includes at least one graphic, picture, item descriptor, or icon representing dining utensils, glasses, dining devices, dining instruments, or specialty items for dining events.

4. The apparatus as recited in claim 1, wherein the item location system includes at least one template, width horizontal distance indicator, length distance indicator, radial distance indicator, or circumferential distance indicator.

5. The apparatus as recited in claim 1 further including a surface coating configured to provide a non-staining interface between the dining surface preparation system and the dining surface area and to provide static friction between the dining surface preparation system and the dining surface area.

6. The apparatus as recited in claim 1 further including at least one template configured to provide an identification and a location of a specialty item on the dining surface area.

7. The apparatus as recited in claim 1 wherein the base includes an arc having a 44.88-degree curvature and a length of 23.5 inches, the base arranged to interface with a 60-inch diameter table.

8. The apparatus as recited in claim 1 wherein the base includes an arc having a 35.97-degree curvature and a length of 22.6 inches, the base arranged to interface with a 72-inch diameter table.

9. The apparatus as recited in claim 1 wherein the base is generally linear and includes a length of 24 inches, the base arranged to interface with a table with straight sides.

10. A dining surface preparation system comprising:
at least one dining device;
a base configured to interface with a dining surface area;
an item identification system positionable on the base arranged to provide identification of at least one dining item; and
an item location system positionable on the base and configured to provide location of the at least one dining item on the dining surface area.

11. The system as recited in claim 10, wherein the at least one dining device includes at least one of a dish, a utensil, and a container.

12. The system as recited in claim 10, wherein the base is configured to interface with a dining surface area having a circular, a square, a rectangular, an oval, or a trapezoidal shape.

13. The system as recited in claim 10, wherein the item identification system includes at least one graphic, picture, item descriptor, or icon representing dining utensils, glasses, dining devices, dining instruments, or specialty items for dining events.

14. The system as recited in claim 10, wherein the item location system includes at least one template, width horizontal distance indicator, length distance indicator, radial distance indicator, or circumferential distance indicator.

15. The system as recited in claim 10 further including a surface coating configured to provide a non-staining interface between the dining surface preparation system and the dining surface area and to provide static friction between the dining surface preparation system and the dining surface area.

16. The system as recited in claim 10 further including at least one template configured to provide an identification and a location of a specialty item on the dining surface area.

17. The system as recited in claim 10 wherein the base includes an arc between 35.97 degrees and 44.88 degrees and a length between 22.6 inches and 23.5 inches, the base arranged to interface with a table having a diameter between 60 inches and 72 inches.

18. The system as recited in claim 10 wherein the base is generally linear and includes a length of 24 inches, the base arranged to interface with a table with straight sides.

19. A method for preparing a dining surface comprising:
interfacing a base with a dining surface area;
identifying at least one dining item with an item identification system positionable on the base; and
locating the at least one dining item on the dining surface area with an item location system positionable on the base.

20. The method as recited in claim 19, wherein the interfacing includes interfacing with circular, square, rectangular, oval, or trapezoidal shaped dining surface areas.
